(19) United States
(12) Patent Application Publication
(10) Pub. No.: US 2009/0234641 A1
(43) Pub. Date: Sep. 17, 2009

(54) METHOD AND SYSTEM FOR ASSISTING THE PROTECTION OF TRADE MARKS

(75) Inventor: Olivier Laidebeur, Hautcharage (LU)

Correspondence Address: CANTOR COLBURN, LLP, 20 Church Street, 22nd Floor, Hartford, CT, 06103, US

(73) Assignee: Office Ernest T. Freylinger S.A., Strassen (LU)

(21) Appl. No.: 12/441,079

(22) PCT Filed: Aug. 21, 2007
(86) PCT No.: PCT/EP2007/058681

§ 371 Date: Mar. 12, 2009

(30) Foreign Application Priority Data
Sep. 12, 2006 (LU) 91 277

(51) Int. Cl. G06F 17/27; G06F 21/00

(52) U.S. Cl. 704/9; 726/26

(57) ABSTRACT

Method for assisting the protection of trade marks comprising the following steps: collecting data comprising at least one natural language term relating to a field of activity, these data being indicated by a user; determining, in an automated manner, on the basis of the natural language term or terms indicated by the user, a suggestion comprising goods and/or services and their respective classes according to an administrative classification, and transmitting the suggestion to the user; receiving data indicative of a selection of good(s) and/or service(s) and/or class(es) chosen by the user from the automated suggestion; and compiling and/or storing this selection. The method can furthermore comprise the automated searching for priorities, the preparing of documents (paper or electronic) necessary for filing a trade mark application, and the tracking of the registration procedure.

### TECHNICAL FIELD OF THE INVENTION

The present invention relates generally to a method and a system aiming to facilitate the steps associated with the preparation of a trade mark application.

### BRIEF SUMMARY OF RELATED ART

As is known, a trade mark is a sign serving to distinguish a person's goods (trade mark) or services (service mark).

Trade mark protection requires an application to be filed for registration of the trade mark, then registration thereof by the relevant authorities (national or regional intellectual property offices) and involves prior preparation of a set of information, in particular determination of the goods and services for which protection is requested in relation to the sign to which the application applies. To do this, a purely administrative system of classifying each good and service into classes of goods and services is used; for each class, a list of goods and services for which protection is requested has to be supplied.

Filing a trade mark application at the relevant offices, whether the trade mark is a national mark, a regional mark (Benelux for example), or a Community or international trade mark, does not necessarily have to involve an intellectual property adviser or specialist lawyer. Nonetheless, for legal entities, companies, tradesmen or individuals wishing to file their trade mark unaided, determination of the classes and preparation of the lists of goods and services is a difficult task because they generally have little or no knowledge of how things are organised. As far as intellectual property specialists are concerned, although they have the advantage of knowing how the various administrative classifications, such as the International Classification of Goods and Services (known as the Nice Classification) are organised, they nonetheless often consult said classification to check or search for the codified terminology relating to their clients' goods and services when preparing applications for said clients.

This is because preparing a list of goods and services which is in accordance with the administrative classification valid in the country in which the trade mark application is to be filed makes it possible to avoid objections from the relevant offices on matters of classification, which speeds up the registration procedure and reduces the costs associated with the registration procedure.

Searches of these classifications are made either using printed versions or electronic versions of the PDF type, which allow users to search the text. However, there is no tool available which makes it straightforwardly possible to draw up a list of goods and services organised by class. What is more, the Nice Classification, which is usually used, comprises terms not easily comprehensible to the public, which complicates searching.

Another important preliminary to filing a trade mark application, although not required by the majority of relevant authorities, is to carry out of a search to determine the existence of prior rights. Such a search may these days be made using databases provided in particular on a worldwide computer network (Internet) or using paper reference works, on the basis of the sign to be protected in combination with the classes representing the goods and services. On the basis of this information, it is possible to determine the appropriateness of an application and, if need be, to adjust the list of goods and services.

Finally, once the classes, goods and services have been determined and the search carried out, it is necessary to enter on the application forms, whether in paper form or electronically, the selected classes and lists of goods and services together with the sign to be protected, the details of the holder, etc.

Thus, preparation of a trade mark application involves complex and varied activities, which are not necessarily carried out by the same person, and requires repeatedly writing out certain data.

It would therefore be advantageous for tools to be available which make it possible to simplify the steps needed to file a trade mark application.

### BRIEF SUMMARY OF THE INVENTION

A first aspect of the present invention relates to a method of assisting in the protection of trade marks comprising the following steps:

collecting data comprising at least one natural language term relating to a field of activity, these data being indicated by a user;

determining in an automated manner, on the basis of the natural language term or terms indicated by the user, a suggestion comprising goods and/or services and their respective classes according to an administrative classification, and transmitting the suggestion to the user;

receiving data indicating a selection of good(s), services(s) and/or class(es) chosen by the user from the automated suggestion; and

compiling and/or storing this selection.

Such a method therefore enables an automated search of the goods, services and classes corresponding to a given field of activity on the basis of one or more natural language terms, the results of the search then being submitted to a user in a structured manner. The user may therefore select the services, goods and classes which he/she wishes to protect by a sign with a view to filing a trade mark application. The use of natural (i.e. non-codified) language is a definite advantage for non-specialists. Furthermore, the automated search makes it possible to go through the entire classification systematically, and therefore ensures nothing is forgotten.

Another advantage of the present method lies in the provision, after acceptance by the user of his/her selection of goods and services from the suggestions, of a list comprising a codified set of goods and services associated with their classes. This selection may therefore be processed in various ways (compiled or stored) depending on the users' needs, and will preferably be displayed and stored (in random access or bulk memory) with a view to being used at the time of actual filing.

It will be understood that the present method is particularly advantageous when several fields of activity need to be taken into account, because the automated processing of the search, and also the possibility of displaying, compiling and/or storing the user's selection, allows the latter to concentrate on just the goods and services, without having previously to find the class. Preferably, the steps of automated determination of a goods and/or services suggestion and of their respective classes followed by transmission of the suggestion to the user, and the step of receiving the selection from the user will be repeated for each of the natural language terms indicated by the user. Compilation of the selection then makes it possible to organise the goods and services automatically by class.

Advantageously, a classification index is associated with each good or service such that it is unique in the classification used. Thus, simply referring to this classification index makes it possible to identify unambiguously a given good or service within a class. These classification indices are therefore sufficient to identify the goods and services selected by the user, with the result that, during compilation or storage, storing of the codified phrases for the goods and services could be omitted.

Furthermore, reference to a unique classification index makes it possible to find a given good or service in several languages. Thus, it will be possible to use a database organised so as to combine the following data: codified phrase for a good or service; classification index; class. For multilingual versions, it will be possible to combine with this set of data the codified phrase for the good or service in the desired languages. For three languages, the database would then include the following combination of data: classification index; class; codified phrase for a good or service in Language_{—}1; codified phrase for a good or service in Language_{—}2; codified phrase for a good or service in Language_{—}3. The classification indices related to the selection of goods and services made by the user therefore make it possible to compile lists of goods and services in each of languages 1 to 3. Alternatively, it is possible to carry out a search of goods and services in language 1 and to compile a list of goods and services in language 2 or 3.

In a particularly advantageous embodiment, a description in everyday language of the good or service concerned is associated with at least some of the goods and services in the database. This description thus clarifies the terminology of the classification and may include several terms or phrases synonymous with or similar to the codified phrase for the good or service. These descriptions in everyday language associated with goods and services in the database will be taken into account during searching of the goods and services. Thus, if the user indicates as field of activity (i.e. the term in natural language) a word or a phrase used in the classification, the search will lead directly to the good(s) or services(s) in question in the database.

Alternatively, if the user does not know the codified phrase for the good or service corresponding to the field of activity and indicates a similar term, if this term is used in the everyday language descriptions associated with the goods and classes, it will be nonetheless be possible to find the codified term according to the classification.

A second aspect of the present invention proposes a method of assisting in the protection of trade marks comprising the following steps:

collecting data comprising a sign to be protected and at least one natural language term relating to a field of activity, these data being indicated by a user;

determining in an automated manner, on the basis of the natural language term or terms indicated by the user, a suggestion comprising goods and/or services and their respective classes according to an administrative classification, and transmitting the suggestion to the user;

receiving data indicating a selection of good(s) and/or services(s) and/or class(es) chosen by the user from the automated suggestion;

determining in an automated manner the existence of an identical and/or similar trade mark already filed in or for at least one country or region and at least for one of the classes selected by the user, and transmitting the results to the user;

receiving data relating to confirmation of the selection of good(s), services(s) and class(es) chosen previously by the user or to modification of this selection;

compiling and/or storing this selection associated with the sign to be protected.

This method allows classes to be determined and a list to be prepared in accordance with the first aspect of the invention, and additionally has the possibility of carrying out a prior rights search on the basis of the previously selected classes. This combination of functions optimises and facilitates the preparation of an application, since the classes selected by the user may be used directly in the prior rights search requests. When presented with the results of the prior rights search, the user is in a position to make his/her final selection from the goods and services which he/she actually wishes to select.

According to one variant, the step of transmitting the results of the automated determination of one or more identical and/or similar trade mark(s) already filed includes at least one of the following items of information: presence of one or more prior rights; number of prior rights; name of each prior right and associated classes; list of goods and services for each class associated with a prior right.

When there are one or more prior rights, the user will be invited to request an analysis of the results of the determination of trade marks already filed; and, in the case of confirmation of such a request, the results are transmitted to a specialist with the compiled data relating to the selection of goods and services and the sign to be protected. Such a request is preferably not transmitted until after verification of payment by the user of a sum required for analysis of the results.

A third aspect of the present invention proposes a method of assisting in the protection of trade marks comprising the following steps:

collecting data comprising a sign to be protected and at least one natural language term relating to a field of activity, these data being indicated by a user;

determining in an automated manner, on the basis of the natural language term or terms indicated by the user, a suggestion comprising goods and/or services and their respective classes according to an administrative classification, and transmitting the suggestion to the user;

receiving data indicating a selection of good(s) and/or services(s) and/or class(es) chosen by the user from the automated suggestion;

determining in an automated manner the existence of an identical and/or similar trade mark already filed in or for at least one country or region and at least for one of the classes selected by the user, and transmitting the results to the user;

receiving data indicated by the user relating to confirmation of the selection of good(s), services(s) and class(es) chosen previously by the user or to modification of this selection;

receiving data comprising a filing instruction for one or more countries together with the identity of a holder, these data being indicated by the user;

compiling and/or storing this selection associated with the sign to be protected as a trade mark, with the countries and with the identity of the holder.

This third method combines the advantages stated above and makes it possible to compile all the data for preparing the actual trade mark application for filing.

Thus, the method advantageously comprises the step of compiling the data for the generation of forms and documents with a view to filing, this generation being effected by printing on paper substrates or by storing these forms or documents in electronic files. It will be noted here that the generation of document and form data from the data compiled may of course be applied to the methods according to the first and second aspects of the invention.

According to one variant, the method advantageously comprises a step of compiling the data for sending off, either directly to the agents in charge of effecting filing or directly to the relevant Trade Mark Office in the format required by said Office in order immediately to obtain a filing date, and optionally a filing number if the Office effects immediate grant. In this case, the compilation and sending off of the data allows the direct acquisition of trade mark rights. It will be noted here that the generation of document and form data or data constituting a filing from the data compiled may of course be applied to the methods according to the first and second aspects of the invention.

“Relevant Trade Mark Office” is taken to mean the authorities qualified to receive an application for registration of a trade mark such as for example OHIM, WIPO, USPTO, BOIP etc.

According to one variant, the present method comprises the processing of images or graphic representations supplied by the user, in the case of trade marks comprising such a graphic representation, so that they meet the administrative requirements and criteria of the Offices. Advantageously, this processing will in particular convert the images or graphic representations to black and white, so as to bestow extended protection on the user's trade mark.

According to one variant, the present method comprises the step of filing with the relevant authorities the generated forms and documents forming the trade mark application. The method then preferably comprises the step of calculating a payment amount corresponding to the sum of the taxes and fees relating to the specific details of the filing or filings requested by the user, transmitting to the user the fees and verification of payment of the fees prior to the filing step. Finally, the method may include steps aiming to ensure monitoring of the trade mark application after filing, normally at least until registration of the trade mark, including the monitoring of deadlines and official notifications from the offices.

The methods described above are advantageously implemented by computer, which is obviously necessary to be able to proceed with the automatic searches within a classification or the prior rights searches.

Typically, the operation of collecting the data will be performed by means of one or more templates at the level of a user terminal, these data then being transmitted to a data processing unit (local or remote). Determination of prior rights will preferably be performed by querying existing databases.

The present invention also relates to a computer system comprising suitable means for implementing the methods in accordance with the different aspects of the invention.

Finally, the present invention relates to a computer program product comprising portions of software code for executing the steps of the methods described above when the program is run on a computer, and also relates to such a computer program product stored on a computer-readable medium.

### DESCRIPTION OF THE DRAWINGS

Other distinctive features and characteristics of the invention will be revealed by the detailed description of some advantageous embodiments given below by way of example, with reference to the appended drawings, in which:

FIGS. 1 and 2 show diagrams illustrating the principal steps of a method according to one preferred variant of the invention; and

FIG. 3 shows an example of the structure of a goods and services database which may used in the method according to the invention.

### DETAILED DESCRIPTION OF THE INVENTION

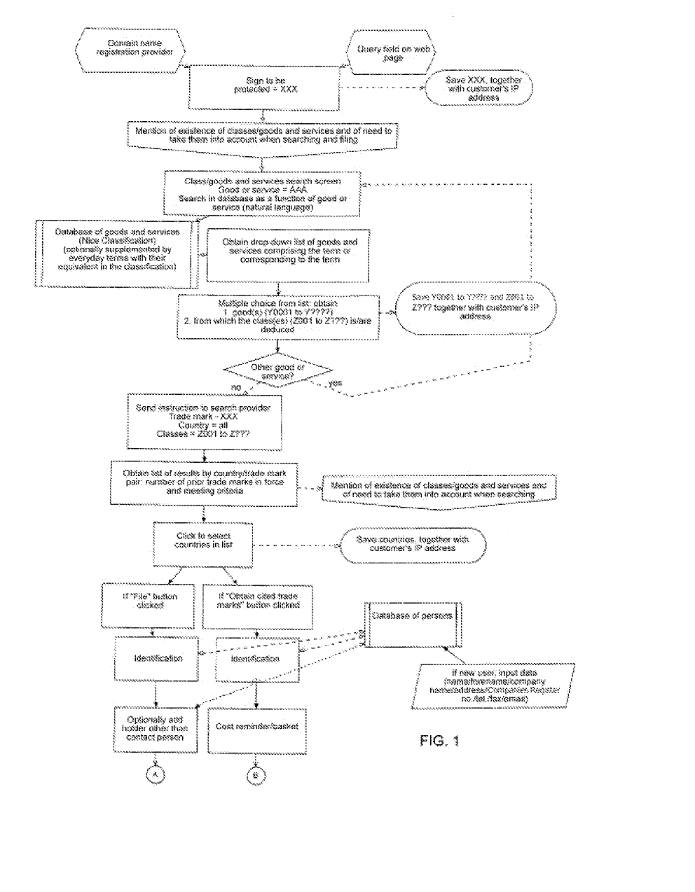

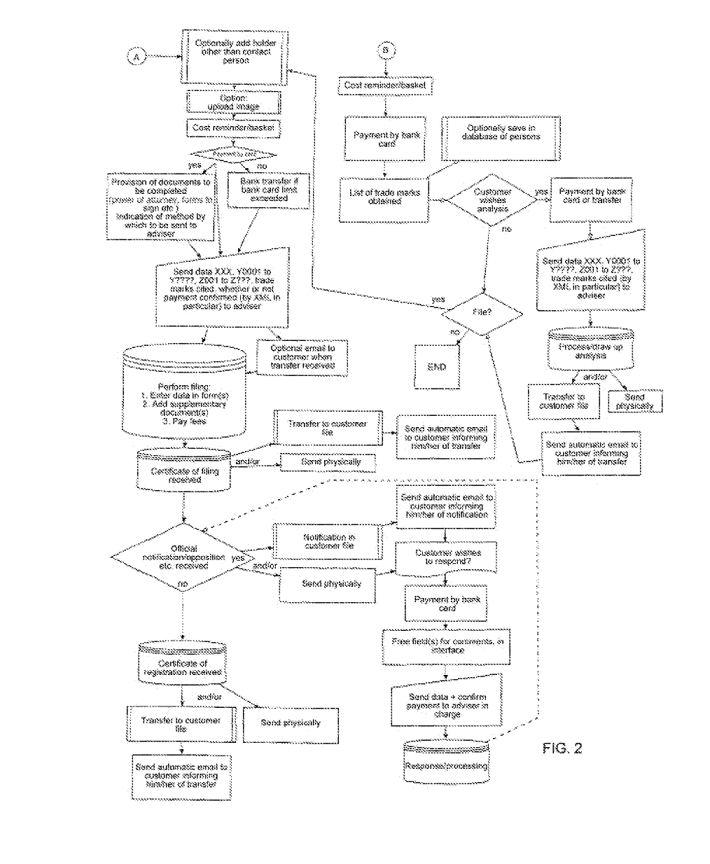

The principal steps of one preferred variant of a method according to the invention applied to an embodiment allowing the on-line preparation of a trade mark filing are illustrated in FIGS. 1 and 2.

Such a method is of course implemented by a computer system comprising all the suitable means necessary for this implementation, such that the terms system and method will be used indiscriminately below.

In the present variant, the system comprises a central data processing unit which communicates, for example via a computer network (for example the Internet) with a user terminal, typically a conventional personal computer. All the data needed to prepare for filling of a trade mark will therefore be collected by means of this user interface, via various screens and templates, whether it is a matter of inputting information or making selections from the choices offered by the system.

The system presents to the user a first welcome page, in which the latter inserts the term, normally known as a sign in the art, which he/she wishes to protect as a trade mark, indicated as XXX in the Figs.

Alternatively, the term/sign in question may be obtained directly from a domain name registration provider.

The sign XXX is saved in the system together with the user's IP address. A unique identification number (hereinafter UIN) is then created on the basis of XXX and of the IP address.

Alternatively, the method advantageously includes entry on the user terminal of a set of information, including the unique identification number (hereinafter UIN) created on the basis of XXX and of the user's IP address.

The welcome page may comprise a mention of the existence of classes/goods and services and the need to take them into account when searching and filing. This is followed by a search page for the classes, goods and services for which the trade mark is or will be used. This page includes a field in which the user is invited to enter a natural language term, indicated as AAA, corresponding to the field of activity relating to the sign to be protected as a trade mark.

In one variant, a single page may comprise (i) a space or field allowing entry of the sign which it is wished to protect as a trade mark, indicated as XXX in the Figs, and (ii) a space or field in which the user may enter a term AAA in natural language corresponding to the field of activity relating to the sign to be protected as a trade mark. The mention of the existence of classes/goods and services and of the need to take them into account when searching and filing is then incorporated by reference to an explanatory page.

Advantageously, a single page may comprise (i) a space or field allowing entry of the sign which it is wished to protect as a trade mark, indicated as XXX in the Figs, (ii) a mention of the existence of classes/goods and services and the need to take them into account when searching and filing, and (iii) a space or field in which the user may enter a term AAA in natural language corresponding to the field of activity relating to the sign to be protected as a trade mark.

On acceptance by the user, the system will perform a search of one or more database(s) of goods and services, using for example the terminology of the Nice Classification.

The database is preferably organised such that for each good or service of the classification a record is provided which includes: a classification index (unique number), the class corresponding to the good or service in question, the good or service according to the terminology of the administrative classification, a description in everyday language of the good or service, and optionally additional information to be requested or additional remarks.

The description in everyday language is intended to clarify the terminology of the classification and may include several terms or phrases synonymous with or similar to the codified phrase for the good or service. During searching of the database, occurrences of the natural language term AAA corresponding to the field of activity are then advantageously searched for in the goods/services fields and also in the fields containing the description in everyday language.

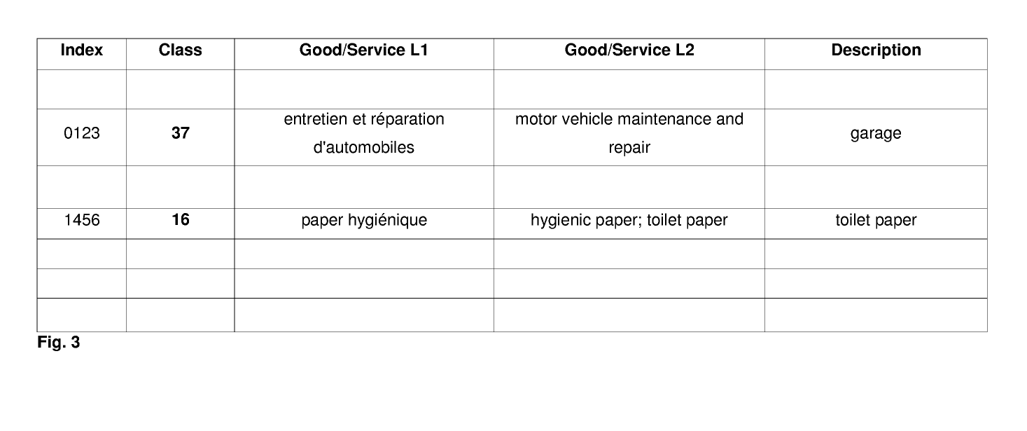

An example of such a database is illustrated in FIG. 3. The database comprises 5 field records. The first, “index” field contains the classification index, which is a unique number to which the other 4 data items in the same line correspond unambiguously: the class, the good or service according to the classification and in the language of the user (Good/Service L1), good or service according to the classification in another language, in this case English (Good/Service L2), and a description in everyday language of the good or service in question.

Referring for example to FIG. 3, it may be seen that, with such a database, a user who wishes to obtain the list of goods and classes with a view to filing a trade mark application in relation to the activity of “garagiste” [“garage owner”] would easily find the official nomenclature and class for this activity, namely: entretien et reparation d'automobile [motor vehicle maintenance and repair], class 37. It will be noted that the term “garagiste” [“garage owner”] is not to be found in the Nice Classification and that a search based solely on the Nice Classification would not have produced a result.

As will also be understood from FIG. 3, the use of a unique classification index makes it possible to find a given good or service in several languages. Following a search of goods and services in the user's language, the database shown makes it possible to generate lists in the user's language and/or another language. In the present example, for completeness' sake, a field ought to be added comprising a description in everyday language in language L2, i.e. English.

Once the search of the database of goods and services has been carried out, the system then transmits to the user's terminal a suggestion of goods, services and classes comprising or associated with the term AAA. This suggestion is presented on the screen such that the user can select one or more goods and/or services from those suggested.

From the database of goods and services and from the selection made by the customer, the system will thus display on the user interface in a first display zone
the good(s) and/or service(s) of interest to the customer (hereinafter Y0001 to Y????)
the associated class(es) (hereinafter Z001 to Z???)

After confirmation by the user, the system saves the data Y0001 to Y???? and Z001 to Z??? together with the UIN, displays the selected term AAA in a second display zone and asks the user is he/she wishes to protect other goods or services.

If the answer is yes, the user is again invited to enter a natural language term to be searched for in the database of goods and services, and the suggestions and selections will be displayed in the manner described above. These steps will be repeated as many times as is necessary. With each new term the first display zone is reset, such that the suggestions from the new search may be displayed therein. The selections from each of the suggestions are brought together in the second display zone and the data Y0001 to Y???? and Z001 to Z??? are saved cumulatively together with the UIN.

In an alternative embodiment, on the basis of the database of goods and services and of the selection made by the customer, the system will thus display on the user interface in a first display zone
the good(s) and/or service(s) which may be of interest to the customer (hereinafter Y0001 to Y????)
the associated class(es) (hereinafter Z001 to Z???)

The user then has the option of choosing (selecting) from the goods and/or services Y0001 to Y???? those which he/she considers correspond to his/her activities in relation to the sign.

Optionally, the system will select all the goods and/or services Y0001 to Y???? which it considers correspond to the expectations of the user, for him/her to choose (deselect) those which he/she considers do not correspond to his/her activities in relation to the sign.

In the case of a negative response according to the first option, and in the event of the user choosing to carry out the search, the method proceeds by sending to a trademark search provider the following data:
trade mark/sign=XXX,
country=all those available
classes=Z001 to Z???

When returned, the results of the search are incorporated into a presentation screen, noting the trade mark/country pairs and displaying the number of valid prior trade marks (filings and/or registrations) meeting the criteria. This presentation screen optionally notes the existence of the classes and of the various goods and/or services in a class and the need to take them into account in the searches in order to interpret them properly. This screen also optionally notes the cost of filing and/or of registering a trade mark right by country and for the classes Z001 to Z999 and/or number of classes and/or number of goods Y0001 to Y???? selected by the user.

The user then selects the country in the list presented to him/her, and confirms. The countries are then saved by the system, together with the UIN.

The user then has three choices:
either he/she wishes to proceed directly to filing;
   or he/she wishes to obtain the trade marks (filed and/or registered) uncovered by the search;
   or he/she wishes to obtain an analysis of the trade marks (filed and/or registered) uncovered by the search;

This choice may also be made at a later stage.

In both cases, or as an alternative to this choice, he/she is then cumulatively, but in no particular order:
asked to identify him-/herself;
reminded of the nature and cost of the services ordered.

As regards identification, the user must register in a database of persons.

One option is for the user to place his/her first order, in which case he/she will be asked to give the details necessary to identify him/her, including in particular but not exclusively his/her name and forename, the name of the company, legal address, address for service, company registration number, telephone and fax numbers and/or email address; he/she will also be asked to select an ID and a password. The identification step may arise at a previous stage in the system, and in particular before proceeding with a search relating to a precise term in the database of goods and services. After accepting and saving the data, the system will continue.

The other option is that the user already has an ID and password, in which case he/she will be invited to provide them, unless he/she has previously connected to the system using these details. He/she will then optionally be reminded of the data provided when he/she registered in the database of persons.

If the user comes from the site of a domain name registration provider, the identification data provided at the time of access to this provider or on registration of a domain name may be used directly by the system.

The data saved together with the UIN are then transferred into the database, under a unique trade mark identifier (hereinafter UTMI).

The system then allows the possibility of uploading an image corresponding to the graphic representation of the sign XXX to be protected, in which case a special note could be inserted in the data with regard to the existence of a semi-figurative trade mark. This graphic representation is saved by the system together with the UTMI.

This uploading may also be carried out at a later stage.

The system may also offer the possibility of adding a holder other than the user as holder of the future trade mark right, in which case the identification data of the bearer are added to the database, and saved together with the UTMI.

This information may also be supplied at a later stage.

If the system has not yet invited the user to choose between proceeding directly to filing or obtaining the trade marks (filed and/or registered) uncovered by the search, he/she is then requested to make this choice.

1. In the Case of Immediate Filing

The user is asked to proceed with payment for the services ordered.

If this amount cannot be paid immediately, in particular by bank card, the data necessary for payment are supplied to him/her, such as for example the data needed for a bank transfer.

The system makes available any documents which need signing and/or completing, optionally previously completed by the system on the basis of data saved together with the UTMI. The system also indicates the mode of transmission of these documents, after completion or signing, together with the addressee of the documents, in particular as a function of the country(ies) chosen, and of the selected classes Z001 to Z??? and goods and services Y0001 to Y????.

As mentioned above, it is possible at this stage to upload an image corresponding to the graphic representation of the term XXX, as well as to add a holder other than the user as holder of the future trade mark right, if this has not been done prior to these operations.

The data XXX, optionally Y0001 to Y????, optionally Z001 to Z???, the identification data of the applicant and, if different, those of the holder, if applicable the graphic representation of the trade mark, payment confirmation or mention of a pending payment are transmitted, preferably electronically, to the person in charge of filing, who may be a representative such as an intellectual property adviser or a lawyer. Typically, the data are transmitted by the central data processing system over the Internet or another network to the computer terminal of the representative.

In the case of deferred payment, a message may inform the user that the payment has been received.

The person in charge of filing than carries out filing, optionally using the system, in particular for insertion of the data into the required forms, adding any documents signed and/or completed by the user, and may optionally, if required, proceed with payment of the official fees to the relevant authority.

On receipt of the filing certificate, if such a thing exists:
an electronic copy of the certificate is transferred to the user's file. An email could then automatically be sent to the user to inform him/her that the certificate is available. And/or
the certificate is sent physically to the user.

On receipt of an official notification, an opposition or any letter, documentation, notification (hereinafter notification) concerning the filing, this is sent on physically and/or a notification is sent within the system to the user's electronic file. In the event of a notification being sent within the system to the user's file, an email could be automatically sent to the user, informing him/her of the existence of this communication.

If the user wishes to reply, he/she may be asked to proceed with payment for the services ordered. Confirmation of the payment is sent via the system to the person in charge of filing.

This payment could allow him/her to access one or more free fields for supplying comments and/or responses, within the system. After acceptance of his/her responses, the system sends the data thus collected to the person in charge of filing.

Alternatively, the user may be asked to send a message, which may or may not be electronic in form, to the person in charge of filing, in order to supply comments and/or responses.

If a new communication is received, the system repeats the same steps as above.

On receipt of the certificate of registration:
an electronic copy of the certificate is transferred to the user's file. An email could then automatically be sent to the user to inform him/her that the certificate is available. And/or
the certificate is sent physically to the user.

2. In the Case of Obtainment or Analysis of the Trade Marks Uncovered by the Search

When the customer has selected a country which is a member of the European Union but has not selected the Community Trade Mark Register, it is advantageously suggested to him/her that he/she add to his/her order the trade marks (filed and/or registered) uncovered by the search in the Community Trade Mark Register.

When the customer has selected a country which is a member of the Madrid Agreement Concerning the International Registration of Marks and/or of the Protocol relating to the Madrid Agreement but has not selected the International Trade Mark Register, it is advantageously suggested to him/her that he/she add to his/her order the trade marks (filed and/or registered) uncovered by the search in the International Trade Mark Register.

The user is asked to proceed with payment for the services ordered. If this amount cannot be paid immediately, in particular by bank card, the data necessary for payment are supplied to him/her, such as for example the data needed for a bank transfer.

In the case of deferred payment, a message may inform the user that the payment has been received.

After receipt of the payment, the system makes available to the user the trade marks (filed and registered in particular) uncovered by the search and optionally saves them in the database.

If the user wishes for an analysis, he/she may be asked to proceed with payment for the services ordered. Confirmation of the payment is sent by the system to the person in charge of analysis, together with copies of the trade marks uncovered by the search, the data XXX, possibly Y0001 to Y9999, optionally Z001 to Z999, optionally the identification data of the applicant and optionally, if different, those of the holder.

When the person in charge of analysis has carried it out, the analysis may be sent physically to the user and/or transferred to the system's user file. In this second case, an email could automatically inform the user of this transfer.

If the user wishes to proceed with filing a trade mark application, the procedure for immediate filing then applies.

It is clear that the present description is merely an example of implementation of the invention and that a person skilled in the art may conceive of a number of variants in accordance with the spirit of the present invention.

1. A method of assisting in the protection of trade marks, comprising the following steps:
collecting data comprising at least one natural language term relating to a field of activity, these data being indicated by a user;
determining in an automated manner, on the basis of the natural language term or terms indicated by the user, a suggestion comprising goods and/or services and their respective classes according to an administrative classification, and transmitting the suggestion to the user;
receiving data indicating a selection of good(s) and/or services(s) and/or class(es) chosen by the user from the automated suggestion; and
compiling and/or storing this selection.

2. A method according to claim 1, in which each codified good or service is associated with a unique classification index.

3. A method according to claim 2, in which a description in everyday language is associated with at least some of the codified goods and services and is taken into account during automated determination on a natural language basis of the suggested goods and/or services and classes.

4. A method according to claim 1, in which compiling is carried out by organising the selected goods and or services by class.

5. A method according to claim 1, in which the compiled data is displayed on a user terminal, printed, stored in random access memory or stored in a bulk memory.

6. A method according to in claim 1, in which the user data are collected by means of a user terminal and transmitted to a central processing unit.

7. A method of assisting in the protection of trade marks, comprising the following steps:
collecting data comprising a sign to be protected and at least one natural language term relating to a field of activity, these data being indicated by a user;
determining in an automated manner, on the basis of the natural language term or terms indicated by the user, a suggestion comprising goods and/or services and their respective classes according to an administrative classification, and transmitting the suggestion to the user;
receiving data indicating a selection of good(s) and/or services(s) and/or class(es) chosen by the user from the automated suggestion;
determining in an automated manner the existence of one or more identical and/or similar trade mark(s) already filed in or for at least one country or region and at least for one of the classes selected by the user, and transmitting the results to the user;
receiving data relating to confirmation of the selection of good(s), services(s) and/or class(es) chosen previously by the user or to modification of this selection;
compiling and/or storing this selection associated with the sign to be protected.

8. A method according to claim 7, in which the step of transmitting the results of the automated determination of one or more identical and/or similar trade mark(s) already filed includes at least one of the following items of information: presence of one or more prior rights; number of prior rights; name of each prior right and associated classes; list of goods and services for each class associated with a prior right.

9. A method according to claim 7, in which the user is invited to request an analysis of the results of the determination of trade marks already filed; and, in the case of confirmation of such a request, the results are transmitted to a specialist with the compiled data relating to the selection of goods and services and the sign to be protected.

10. A method according to claim 9, in which such a request is not transmitted until after verification of payment by the user of a sum required for analysis of the results.

11. A method of assisting in the protection of trade marks, comprising the following steps:
collecting data comprising a sign to be protected and at least one natural language term relating to a field of activity, these data being indicated by a user;
determining in an automated manner, on the basis of the natural language term or terms indicated by the user, a suggestion comprising goods and/or services and their respective classes according to an administrative classification, and transmitting the suggestion to the user;
receiving data indicating a selection of good(s) and/or services(s) and/or class(es) chosen by the user from the automated suggestion;
determining in an automated manner the existence of an identical and/or similar trade mark already filed in or for at least one country or region and at least for one of the classes selected by the user, and transmitting the results to the user;
receiving data indicated by the user relating to confirmation of the selection of good(s), services(s) and class(es) chosen previously by the user or to modification of this selection;
receiving data comprising a filing instruction for one or more countries together with the identity of an applicant, these data being indicated by the user;
compiling and/or storing this selection associated with the trade mark to be protected, with the countries and with the identity of the applicant.

12. A method according to claim 11, comprising compiling the data for the generation of forms and documents with a view to filing, this generation being effected by printing on paper substrates or by storing these forms or documents in electronic files.

13. A method according to claim 12, comprising the step of filing with the relevant authorities the generated forms and documents forming the trade mark application.

14. A method according to claim 12, comprising the step of sending to the relevant authorities the information, generated forms and documents forming the trade mark application, then receiving the filing data.

15. A method according to claim 11, comprising the step of calculating a payment amount corresponding to the sum of the taxes and fees relating to the specific details of the filing or filings requested by the user, transmitting to the user the fees and verification of payment of the fees prior to the filing step.

16. A computer system comprising suitable means for implementing the method of assisting in the protection of trade marks according to claim 11.

17. A computer program product comprising portions of software code for executing the steps of the method according to claim 1 when said program is run on a computer.

18. A computer program product comprising portions of software code recorded on a computer-readable medium for executing the steps of the method according to claim 1 when said program is run on a computer.

19. A method according to claim 1, in which a description in everyday language is associated with at least some of the codified goods and services and is taken into account during automated determination on a natural language basis of the suggested goods and/or services and classes.
